(19) United States
(12) Patent Application Publication
(10) Pub. No.: US 2009/0280911 A1
(43) Pub. Date: Nov. 12, 2009

(54) GAMING SYSTEM WITH SLIDE-OUT FRAME

(76) Inventor: Victor Tsao, Park City, UT (US)

Correspondence Address: DAVID R. MCKINNEY, P.C., P.O. BOX 1460, SANDY, UT, 84091, US

(21) Appl. No.: 12/119,166

(22) Filed: May 12, 2008

(51) Int. Cl. A63F 13/08

(52) U.S. Cl. 463/46

(57) ABSTRACT

A gaming system includes a housing having a front opening with a perimeter, a frame having a front, and a front panel attached to the front of the frame. The frame supports the functional components of the gaming device, and is slidably moveable from a closed position in which the frame is substantially completely enclosed within the housing, to a service position in which the frame is extended at least partially forwardly through the front opening. The front panel is configured to mate with the perimeter of the front opening of the housing when the frame is in the closed position.

### BACKGROUND

The present invention relates generally to gaming devices (e.g. slot machines and the like), such as are typically found in casinos. Many freestanding gaming devices include a decorative front door that is hingedly connected along a side edge to the gaming device cabinet. When it is necessary to service the machine, the door can be opened by unlocking a latch and swinging the door open. Attached to the door can be control devices (e.g. push buttons, levers, etc.), video displays, bill acceptors, coupon printers, coin or token dispensers, and other mechanical and electrical devices, in addition to attractive trim and other decorations to improve the appearance of the device. In some cases, all or nearly all functional elements of the gaming device are attached to the door.

With so much structure attached to the door, the door can become relatively thick and heavy. This configuration necessitates strong hinges and a strong cabinet to support the weight of the door, which adds to the cost of the gaming device. Additionally, gaming devices are frequently placed close together in rows, and purchasers of these devices often desire to place them as close together as possible. A relatively thick door necessitates a certain amount of lateral space for the door swing, thus increasing the minimum space between adjacent machines. Furthermore, when the door of the gaming device is opened for servicing, it can interfere with an adjacent gaming position because of its thickness, thus effectively making two machines unusable when one needs servicing.

### SUMMARY

It has been recognized that it would be advantageous to develop a gaming system that allows easy access to the functional components of the device for service personnel.

It has also been recognized that it would be advantageous to develop a gaming system that allows service access to the interior of the device with minimal disturbance of adjacent gaming positions.

It has also been recognized that it would be advantageous to have a gaming system in which the decorative portions of the device can be quickly and easily interchanged.

It has also been recognized that it would be advantageous to have a gaming system which provides a large video display with a minimum operational cabinet width.

In accordance with one embodiment thereof, the present invention provides a gaming device having a housing having a front opening with a perimeter, a frame having a front, and a front panel attached to the front of the frame. The frame supports the functional components of the gaming device, and is slidably moveable from a closed position in which the frame is substantially completely enclosed within the housing, to a service position in which the frame is extended at least partially forwardly through the front opening. The front panel is configured to mate with the perimeter of the front opening of the housing when the frame is in the closed position.

In accordance with another aspect thereof, the invention provides a gaming system, including a frame having a front, and an interchangeable front panel, removably and non-hingedly attachable to the front of the frame. The frame includes a fully integrated gaming platform for supporting an embedded computer device programmed to conduct an electronic game of chance in response to user input, and a printer support for supporting a printer to provide a verifiable indication of the game results. The frame is configured for slidable attachment within a housing having a front opening so as to be moveable between a closed position in which the frame is substantially completely enclosed within the housing, to a service position in which the frame is extended forwardly through the front opening and the microprocessor and printer supports are at least partially exposed. The front panel, includes gaming control devices and at least one gaming display, and is configured to mate with a perimeter of the front opening of the housing when the front panel is attached to the frame and the frame is in the closed position.

### BRIEF DESCRIPTION OF THE DRAWINGS

Additional features and advantages of the invention will be apparent from the detailed description which follows, taken in conjunction with the accompanying drawings, which together illustrate, by way of example, features of the invention, and wherein:

FIG. 1 is a front perspective view of one embodiment of a gaming system with a slide-out frame in accordance with the present disclosure, showing the frame extended forward to a servicing position;

FIG. 2 is a front perspective view of the gaming system of FIG. 1, showing the frame retracted into the gaming system housing to a use position;

FIG. 3 is a rear perspective view of the gaming system of FIG. 1, with the frame extended to the servicing position, and showing the housing in dashed lines;

FIG. 4 is a front exploded perspective view of one embodiment of a frame and front panel for a gaming system configured in accordance with the present disclosure; and

FIG. 5 is a front perspective view of an alternative embodiment of a front panel that can be used with a gaming system configured in accordance with the present disclosure.

### DETAILED DESCRIPTION

Reference will now be made to exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

As noted above, many freestanding gaming devices, such as are typically found in casinos, include a decorative front door that is hingedly connected along one edge to the cabinet of the gaming device. The door can have control devices (e.g. push buttons, levers, etc.), video displays, bill acceptors, coupon printers, coin or token dispensers, and other mechanical and electrical devices connected to it. With so much structure attached to the door, the door can become relatively thick and heavy, which necessitates strong hinges and a strong cabinet to support the weight of the door, and can require a relatively large space between adjacent machines to allow the door to open for servicing. When the door of the gaming device is opened for servicing, it can make two machines unusable when only one needs servicing, because its thickness can interfere with an adjacent gaming position.

Advantageously, the inventor has developed a gaming system having a carriage or frame that slides forwardly out of a housing to allow easy access to the mechanical and electrical components of the device for servicing, maintenance, etc. Because the gaming device uses a slide-in frame instead of a swinging door, the device can be easily serviced with minimum disturbance of adjacent gaming positions. Additionally, this gaming system provides a large video display with a minimum operational cabinet width.

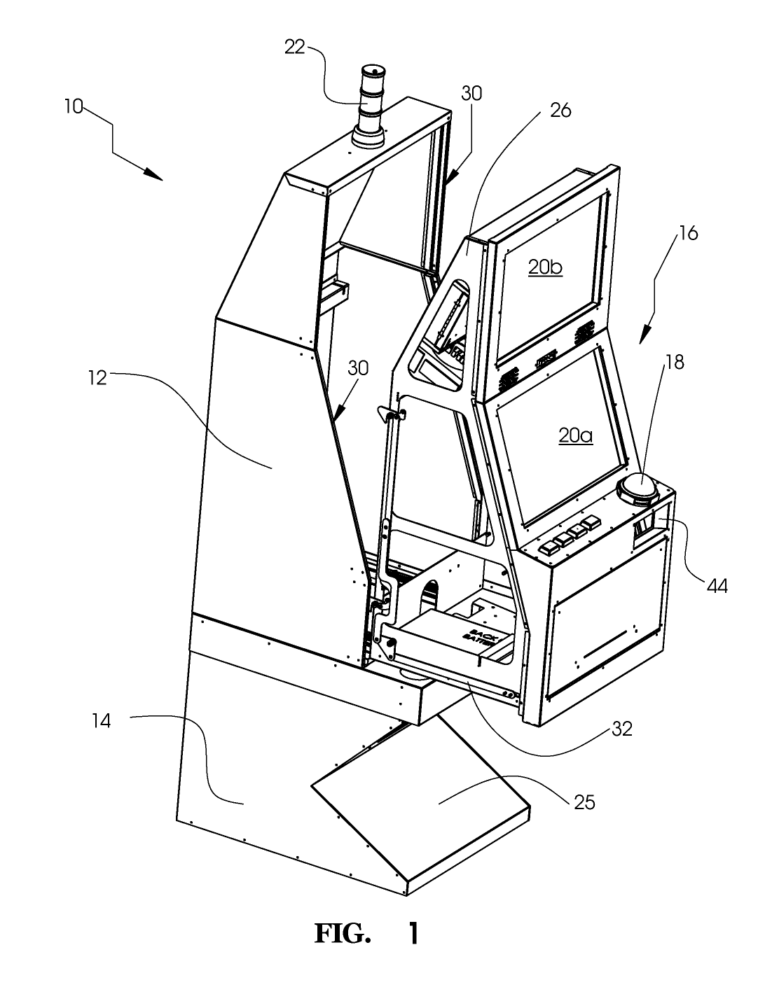

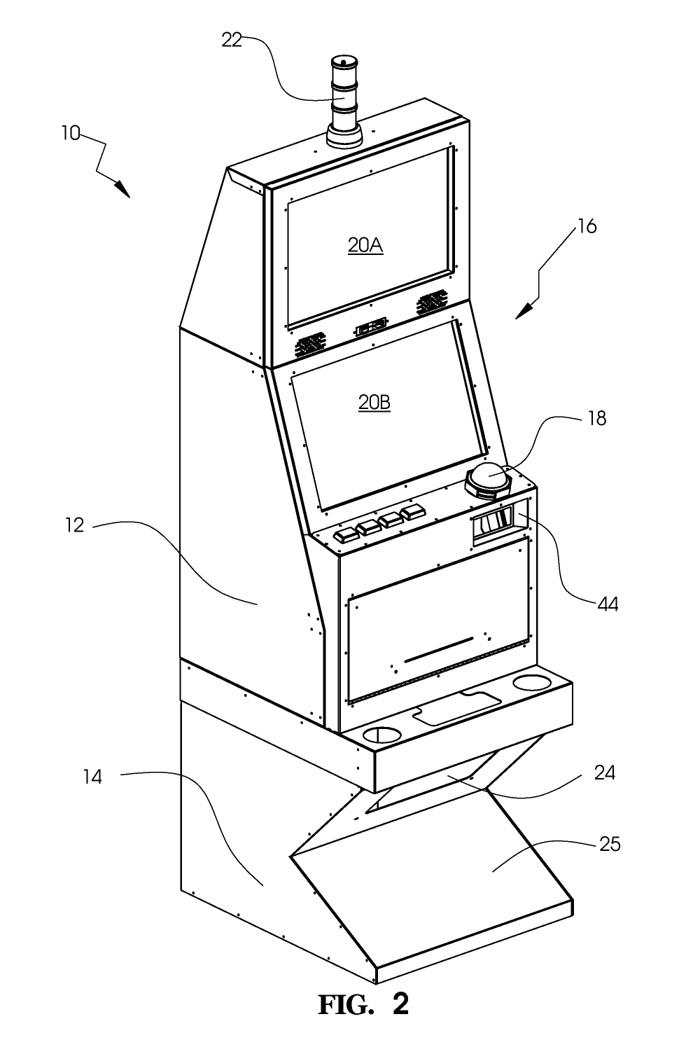

Shown in FIGS. 1 and 2 is a front perspective view of one embodiment of a gaming system with a slide-out frame. This system includes many features that are found on many types of gaming systems. The gaming system 10 generally comprises a cabinet or housing 12 mounted upon a base 14, and having a front face 16 providing gaming control devices 18 (e.g. buttons, levers, etc.) and one or more displays 20. The displays can include a gaming display 20a, and a secondary video display 20b, if desired. Other elements can also be included on the front face or panel 16 or on the housing 12, such as audio speakers, lighting elements, decorative indicia, etc. (not shown). The gaming system can also include a pull arm (not shown) disposed on a side of the housing, for operating the gaming device in the manner of a traditional mechanical slot machine. A win indicator light 22 can also be located on top of the housing. The base 14 can include an access door 24 allowing service accesses to a region below the housing 12. The base can also include an indented, sloped face 25 for providing a footrest area for users of the gaming device.

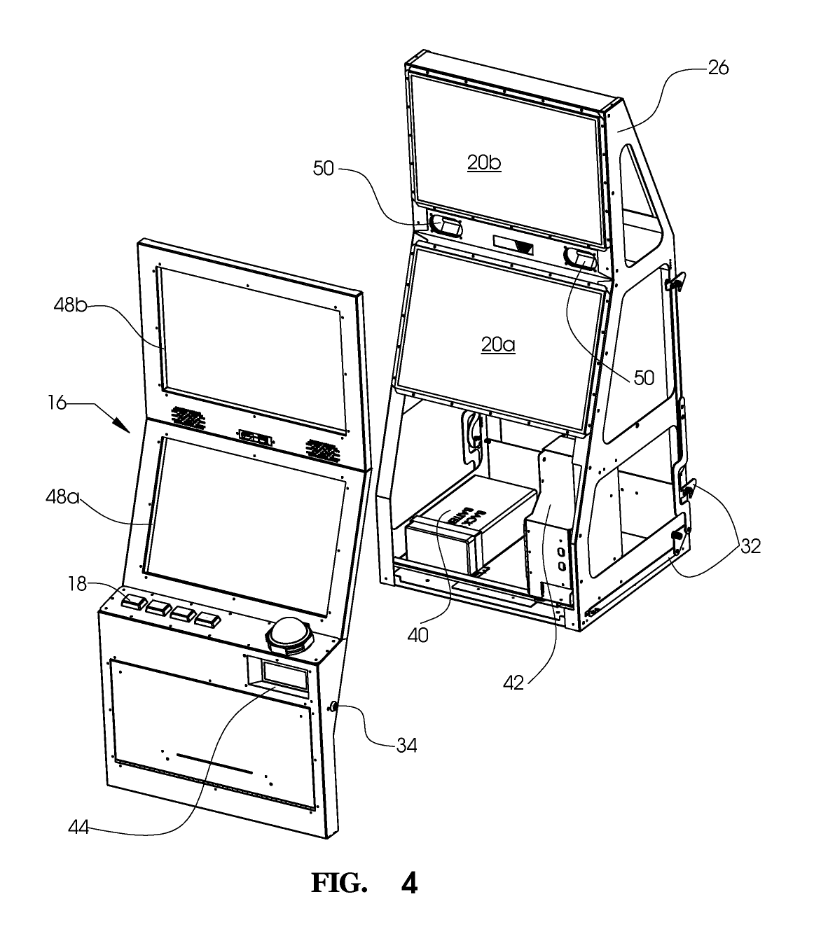

Referring to FIG. 1, the gaming system 10 includes a frame 26 that slides into and out of the housing 12. The housing has a front edge 30 that defines a front opening or perimeter of the housing. The frame can be mounted on runners 28 or other sliding structure in the bottom of the housing (i.e. atop the base 14), which allow it to slide into and out of the front opening of the housing. The frame is slidably moveable on the runners from a closed position in which the frame is substantially completely enclosed within the housing (as shown in FIG. 2), to a service position in which the frame is extended at least partially forwardly through the front opening (as shown in FIG. 1). The frame can include a latch mechanism 32 that latches the frame into place when it is slid to the closed position. A security lock 34 (visible in FIG. 4) can be interconnected to the latch mechanism to prevent the gaming device from being opened except by authorized persons.

Advantageously, the frame 26 can be removable from the runners 28, so that the entire frame can be detached from the base 14 and removed from housing 12, such as for service or replacement. In the embodiments shown herein, the frame is interconnected to the housing only by the runners when in the service position.

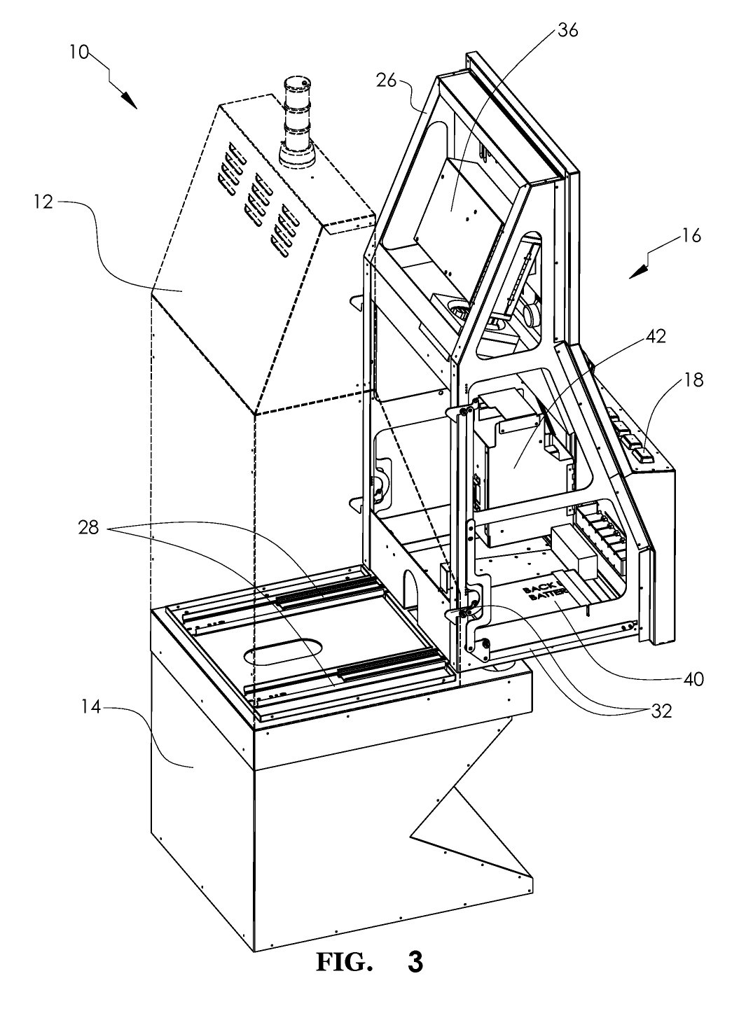

The frame 26 can support most or all of the functional elements of the gaming device 10. This configuration provides a fully integrated gaming platform, in which the entire gaming system is totally self-contained within a single enclosure or chassis. While all of the functional elements of the gaming device are not shown in the figures, the structure for containing or supporting many types of components is shown. For example, as shown in FIGS. 3 and 4, the frame can support a computer controller housing 36 (for containing a microprocessor controller providing an embedded computer system), a backup battery housing 40 and a printer mount 42 (for receiving a printer for printing redemption coupons). The gaming device can also include a bill acceptor (not shown) for receiving currency, or a magnetic card reader (not shown) for reading a credit card or smart card. The computer controller housing can be hingedly attached to the frame, to facilitate easy access to and maintenance or replacement of the computer controller. This can allow relatively simple and inexpensive changing of games that are provided by the gaming device. As with many gaming devices, the embedded computer system can be programmed to conduct an electronic game of chance in response to user input. There are a wide variety of such games, and the gaming device disclosed herein can be configured to present any such compatible game, whether now known or later developed. Embedded computer systems that can be used in this application can be robust and high performance computer systems.

A printer (not shown) that is attached to the printer mount 42 can provide a verifiable indication of the game results, allowing a game participant to exchange the redemption coupon for a prize. As shown in FIGS. 1 and 2, the front panel 16 can include a coupon dispensing slot 44 that communicates with the coupon printer to allow a user to retrieve a redemption coupon.

As with gaming devices generally, this gaming device 10 can be configured for activation using a credit card, a smart card, or currency. While currency acceptors and magnetic card readers are not particularly shown in the figures, it is to be understood that the device can be actuated by any know method for actuating gaming devices. Likewise, the device can provide output to a user in any suitable manner, such as through redemption coupons as discussed above, via adding value to a smart card, or through direct currency distribution through a currency or coin dispenser. It is to be understood that supports and connections for other mechanical and electrical devices or components can also be associated with the frame 26. The various supports can include their own security locks and devices to prevent theft or tampering, in addition to the locking device that is used to lock the frame and front panel in the closed position.

Because of the slide-out frame configuration, when servicing is required, the frame 26 can be slid from the closed position (shown in FIG. 2), in which the frame is substantially completely enclosed by the housing 12, to the service position (shown in FIG. 1), in which the frame is extended forwardly through the front opening 30 of the housing. In the service position, the microprocessor, printer, and other components of the gaming device are at least partially exposed, making maintenance easier.

Attached to the front of the frame 26 is an interchangeable decorative front panel 16. While this front panel can be called a “door”, it is not a door in the typical sense because it is not attached with hinges and is not intended to open by itself. Unlike the swinging doors of other gaming devices, this front panel is not hingedly attached to the front of the frame. It does not swing, but can instead be directly attached with screws, bolts, releasable connectors, etc. The front panel 16 is designed to be easily removed from the frame 26 so that it can be replaced with a different front panel if desired, for example, to change the appearance of the gaming device. However, the front panel is not intended to be opened for routine servicing of the machine or for access to the functional components of the machine. The front panel is configured to mate with the perimeter of the front opening 30 of the housing 12 when the front panel is attached to the frame and the frame is in the closed position, as shown in FIG. 2. As shown in FIGS. 1 and 3, the front panel can include a latch mechanism 32 that is configured to interlock the frame and the housing when the frame is in the closed position.

A view of the front panel 16 detached from the frame 26 is shown in FIG. 4. The embodiment shown in FIGS. 1-4 is a video game configuration, with two video displays 20a, b. The main video display 20a can be the game display, while the secondary display 20b can provide a secondary display, such as for entertainment, advertising, etc. In the view of FIG. 4 it can be seen that the video displays are attached to the frame 26. The front panel includes display frames 48 that surround the video displays to provide a neat, finished appearance. The display frames can also include a transparent lens or protective window that covers the video displays to protect them from contact and damage. In this view some additional elements of the system can be seen, such as audio speakers 50 that are attached to the frame between the video displays. As noted above, the front panel can include decorative elements and indicia (e.g. trim pieces, illustrations, etc.), in addition to other elements such as gaming control devices 18 (buttons, levers, etc.), lighting elements (not shown), etc.

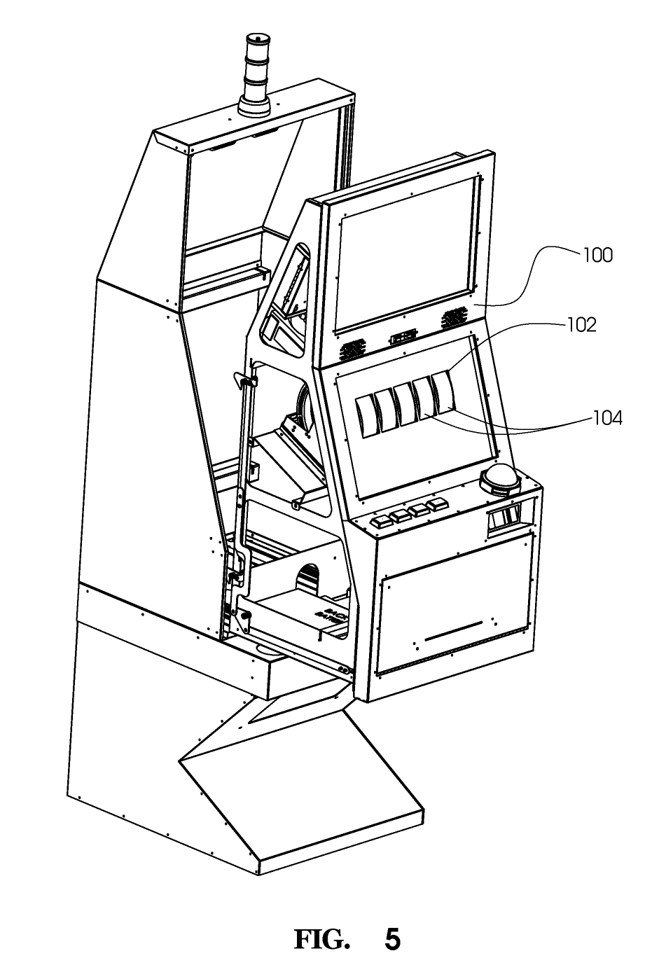

The front panel is configured to be easily replaceable when a different appearance is desired. Additionally, different front panels can be used for different types of gaming devices. For example, as shown in FIG. 5, an alternative front panel 100 includes windows 102 for viewing rotating wheels 104 of a mechanical slot machine, or other mechanical or electrical devices that are located behind the front face. The front panel can include additional features if desired, such as a footrest, an armrest, a cup holder, etc. By replacing the front panel, multiple different front panels can be selectively associated with a single gaming device. The front panel thus essentially provides a removable decorative covering or “door” that attaches to the front of the slide-out cage.

The gaming system disclosed herein advantageously provides a frame that can contain all functional elements of the gaming device, and which slides forwardly out of the cabinet to allow easy servicing without infringing upon the space allocated to gaming devices to either side. Since there is no thick door, adjacent devices can be closer together. Advantageously, the slide-out configuration helps provide a very large video display area, with a minimum operational cabinet width. Additionally, since there are no heavy hinges to support, the housing or cabinet need not be as robust, and can be easily changed by sliding the cage out of one cabinet and into another. Advantageously, the slide-out frame can be shipped in kit form and assembled at or near the site of use, thus saving shipping costs.

It is to be understood that the above-referenced arrangements are illustrative of the application of the principles of the present invention. It will be apparent to those of ordinary skill in the art that numerous modifications can be made without departing from the principles and concepts of the invention as set forth in the claims.

What is claimed is:

1. A gaming device, comprising:
a housing, having a front opening with a perimeter;
a frame, having a front, supporting functional components of the gaming device, being slidably moveable from a closed position in which the frame is substantially completely enclosed within the housing, to a service position in which the frame is extended at least partially forwardly through the front opening; and
a front panel, attached to the front of the frame, configured to mate with the perimeter of the front opening of the housing when the frame is in the closed position.

2. A gaming device in accordance with claim 1, further comprising a base, supporting the housing, the frame, and the front panel.

3. A gaming device in accordance with claim 1, further comprising runners, slidably supporting a bottom of the frame upon a bottom inner surface of the housing, the frame being interconnected to the housing only by the runners when in the service position.

4. A gaming device in accordance with claim 3, wherein the runners are releasable, whereby the frame can be disconnected and removed from the housing.

5. A gaming device in accordance with claim 1, further comprising a latch, associated with the front panel, configured to interlock the front panel and the housing when the frame is in the closed position.

6. A gaming device in accordance with claim 1, wherein the front panel is removably connected to the front of the frame, and is interchangeable with other front panels, whereby multiple different front panels can be selectively associated with the gaming device.

7. A gaming device in accordance with claim 1, wherein the functional components include devices selected from the group consisting of an embedded computer system, audio speakers, a currency or coin acceptor, a currency or coin dispenser, and a printer for printing a redemption coupon.

8. A gaming device in accordance with claim 7, wherein the embedded computer system is configured to conduct an electronic game of chance in response to user input, and is hingedly attached to the frame, to facilitate servicing and interchanging of the microprocessor.

9. A gaming device in accordance with claim 1, wherein the housing further includes at least one device selected from the group consisting of audio speakers, lighting elements, decorative indicia, and a pull arm disposed on a side of the housing.

10. A gaming device in accordance with claim 1, wherein the front panel includes at least one device selected from the group consisting of gaming control devices, a video display, audio speakers, decorative indicia, lighting elements, a footrest, and an armrest.

11. A gaming system, comprising:
a frame, configured to support a game mechanism for playing a game of chance in response to user input, and to provide a verifiable indication of the game results to a user, having at least one gaming feedback device, the frame having a front and being configured for slidable attachment within a housing having a front opening, the frame being moveable between a closed position in which the frame is substantially completely enclosed within the housing, to a service position in which the frame is extended forwardly through the front opening and the game mechanism is at least partially exposed; and
an interchangeable front panel, removably and non-hingedly attachable to the front of the frame, the front panel having gaming control devices and being configured to mate with a perimeter of the front opening of the housing when the front panel is attached to the frame and the frame is in the closed position.

12. A gaming device in accordance with claim 11, wherein the gaming feedback device comprises a video display.

13. A gaming device in accordance with claim 12, wherein the front panel further comprises a window frame, configured to surround the video display, to allow viewing thereof through the front panel.

14. A gaming device in accordance with claim 11, further comprising runners, slidably supporting a bottom of the frame upon a bottom inner surface of the housing, the frame being interconnected to the housing only by the runners when in the service position.

15. A gaming device in accordance with claim 11, wherein the game mechanism is selected from the group consisting of an electronic game, an electromechanical game, and a mechanical game.

16. A method for maintaining a gaming device, comprising the steps of:
releasing a latch associated with a front and a housing of a gaming device configured for playing a game of chance;
sliding a frame of the gaming device forwardly out of the housing to a service position, at which position functional components of the gaming device supported by the frame and disposed behind a front panel non-hingedly attached to the frame are at least partially exposed; and
performing a maintenance action on the gaming device with the frame in the servicing position.

17. A method in accordance with claim 16, further comprising the step of sliding the frame into the housing to a closed position wherein the front panel mates with a perimeter of a front opening of the housing.

18. A method in accordance with claim 16, further comprising the step of removing the front panel from the frame and attaching a new front panel to the frame.

19. A method in accordance with claim 16, wherein the maintenance action comprises replacing a microprocessor associated with the gaming device, whereby the device is caused to conduct a different game of chance.

20. A method in accordance with claim 16, further comprising the steps of:
detaching the frame from the housing and attaching a new frame having a front panel attached thereto and supporting functional components for a game of chance; and
sliding the new frame into the housing to a closed position wherein the front panel mates with a perimeter of a front opening of the housing.
